(19) United States
(12) Patent Application Publication
(10) Pub. No.: US 2025/0054309 A1
(43) Pub. Date: Feb. 13, 2025

(54) METHOD AND MOBILE TERMINAL FOR SHIP RECOGNITION FOR MARITIME PERIMETER MONITORING

(71) Applicant: KOREA INSTITUTE OF OCEAN SCIENCE & TECHNOLOGY, Busan (KR)

(72) Inventors: Young Hoon YANG, Daejeon (KR); Se Kil PARK, Daejeon (KR)

(21) Appl. No.: 18/733,510

(22) Filed: Jun. 4, 2024

(30) Foreign Application Priority Data
Aug. 9, 2023 (KR) 10-2023-0104140

(51) Int. Cl. G06V 20/52; H04N 23/695

(52) U.S. Cl. CPC G06V 20/52; H04N 23/695

(57) ABSTRACT

Proposed are a method and a mobile terminal for ship recognition for maritime perimeter monitoring. The method may include outputting a real-time camera image obtained by capturing the sea with a camera provided in the mobile terminal, and transmitting an information request including location information of the mobile terminal to a collection server that collects ship information in real-time according to the output of the real-time camera image. The method may also include receiving ship information of ships within a preset distance from a location of the mobile terminal from the collection server according to the information request, and fusing and outputting the ship information into each ship image in the output real-time camera image by using the received ship information.

### CROSS REFERENCE TO RELATED APPLICATION

The present application claims priority to Korean Patent Application No. 10-2023-0104140 filed on Aug. 9, 2023, the entire contents of which is incorporated herein for all purposes by this reference.

### BACKGROUND

### Technical Field

The present disclosure relates to a method and a mobile terminal for ship recognition for maritime perimeter monitoring.

### Description of Related Technology

Maritime perimeter monitoring can be said to be a series of processes that promote the safety of citizens and national security by recognizing abnormal maritime situations such as abnormally behaving ships, maritime accidents, and illegal maritime activities at an early stage through continuous maritime observation. With the advancement of technology, recent maritime perimeter monitoring utilizes a variety of sensors and systems, such as cameras, radar, AIS, V-PASS, and e-Navigation, in combination so as to enable more accurate and precise maritime perimeter monitoring.

### SUMMARY

One aspect is a method and a mobile terminal for ship recognition for maritime perimeter monitoring that output an augmented reality screen obtained by fusing information on a corresponding ship into the ship shown in a real-time maritime image captured with a camera of a mobile terminal.

Another aspect is a method of recognizing a ship for maritime perimeter monitoring performed by a mobile terminal, the method comprising: outputting a real-time camera image obtained by capturing the sea with a camera provided in the mobile terminal, transmitting an information request including location information of the mobile terminal to a collection server that collects ship information in real-time according to the output of the real-time camera image, receiving ship information of ships within a preset distance from a location of the mobile terminal from the collection server according to the information request, and fusing and outputting the ship information into each ship image in the output real-time camera image by using the received ship information.

The collection server receives and stores ship information of all ships sailing in a preset control area in real-time from an automatic identification system (AIS), V-PASS, and an ultra-high-speed maritime wireless communication network (LTE-M).

The ship information includes a ship name, ship specifications, current date and time, a call sign, an identification number, a location, a speed, a course, and a rate of turn.

The fusing and outputting the ship information displays the ship information around each ship image shown in the real-time camera image by using location, altitude, and PTZ (pan-tilt-zoom) information of the camera of the mobile terminal and the ship information collected for the ships within the preset distance from the location of the mobile terminal.

The fusing and outputting the ship information displays a ship name around each ship image shown in the real-time camera image, and outputs entire ship information of a touch-inputted ship image via a pop-up window when a touch input to a ship image is received.

Another aspect is a mobile terminal configured to perform a method of recognizing a ship for maritime perimeter monitoring, the mobile terminal comprising: a memory configured to store instructions and a processor configured to execute the instructions, wherein the instructions perform the method of recognizing a ship for maritime perimeter monitoring including outputting a real-time camera image obtained by capturing the sea with a camera provided in the mobile terminal, transmitting an information request including location information of the mobile terminal to a collection server that collects ship information in real-time according to the output of the real-time camera image, receiving ship information of ships within a preset distance from a location of the mobile terminal from the collection server according to the information request, and fusing and outputting the ship information into each ship image in the output real-time camera image by using the received ship information.

The method and mobile terminal for ship recognition for maritime perimeter monitoring in accordance with the embodiments of the present disclosure can output an augmented reality screen obtained by fusing information on a corresponding ship into the ship shown in a real-time maritime image captured with a camera of a mobile terminal.

### BRIEF DESCRIPTION OF THE DRAWINGS

FIG. 1 is a diagram showing an identification procedure for unidentified ships through mutual cooperation between maritime perimeter monitoring units.

FIG. 2 shows views of examples of ship recognition screens for each maritime perimeter monitoring unit.

FIG. 3 is a flowchart showing a method of recognizing a ship for maritime perimeter monitoring performed by a mobile terminal in accordance with an embodiment of the present disclosure.

FIG. 4 is a diagram for describing the method of recognizing a ship for maritime perimeter monitoring in accordance with an embodiment of the present disclosure of FIG. 3.

FIG. 5 is a diagram schematically illustrating the configuration of a mobile terminal configured to perform a method of recognizing a ship for maritime perimeter monitoring in accordance with an embodiment of the present disclosure.

### DETAILED DESCRIPTION

For rapid and accurate maritime perimeter monitoring, identification procedures for unidentified ships through mutual cooperation and information exchange among perimeter monitoring units such as indoor general situation rooms, outside coastal areas, and maritime perimeter monitoring ships are of great importance.

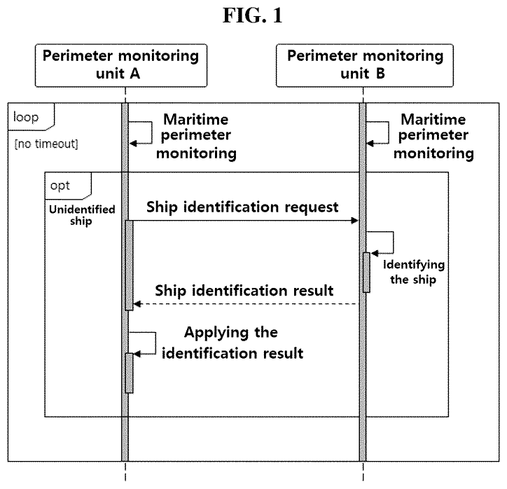

FIG. 1 is a diagram showing an identification procedure for unidentified ships through mutual cooperation between maritime perimeter monitoring units.

Referring to FIG. 1, the identification procedure for unidentified ships is a procedure in which if an unidentified ship that is difficult to identify by any one maritime perimeter monitoring unit on its own appears during the maritime perimeter monitoring by each maritime perimeter monitoring unit, a ship identification request is sent to another perimeter monitoring unit, the other perimeter monitoring unit identifies the ship and returns the result to the requesting unit, and then the unidentified ship is resolved by applying the identification result.

Current video-based maritime perimeter monitoring systems monitored and identified ships at sea by utilizing fixed cameras installed on land, or identified ships by utilizing separate monitoring systems. Because of this, a large number of coastal perimeter monitoring cameras must be installed, which in turn requires a lot of personnel to monitor them.

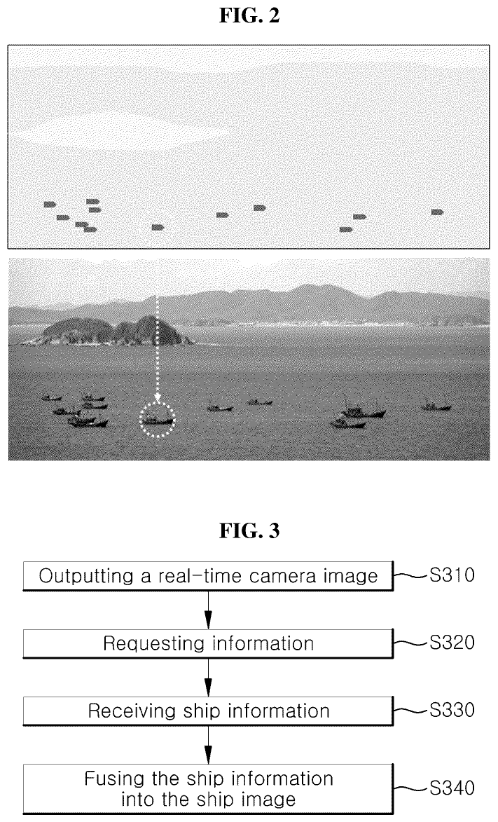

FIG. 2 shows views of examples of ship recognition screens for each maritime perimeter monitoring unit.

When performing the identification procedure for unidentified ships in existing maritime perimeter monitoring, each maritime perimeter monitoring unit has a different location and situational awareness environment, as shown in FIG. 2. Here, the situational awareness environment may include two-dimensional maps, CCTV images, maritime perimeter monitoring ships, actual coastal areas, etc. Therefore, because the mapping of the same ship, object, terrain feature, or the like was based on verbal descriptions when exchanging information between maritime perimeter monitoring units, it took a long time and there was a high probability of making errors.

Singular expressions as used herein include plural expressions unless the context clearly dictates otherwise. As used herein, terms such as “comprise” or “include” should not be construed as necessarily including all of the various components or steps described herein, but should be construed in such a way that some of the components or steps may not be included or additional components or steps may further be included. In addition, terms such as “ . . . part” and “module” described herein refer to a unit that processes at least one function or operation, and may be implemented in hardware or software, or in a combination of hardware and software.

Hereinafter, various embodiments of the present disclosure will be described in detail with reference to the accompanying drawings.

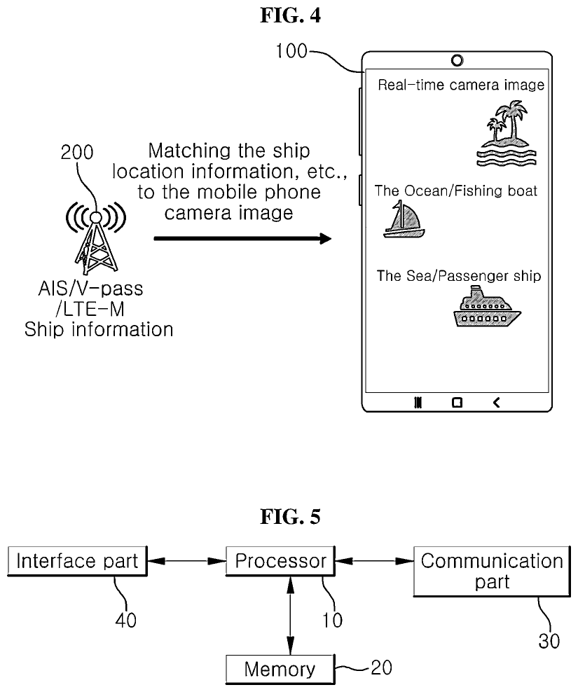

FIG. 3 is a flowchart showing a method of recognizing a ship for maritime perimeter monitoring performed by a mobile terminal in accordance with an embodiment of the present disclosure, and FIG. 4 is a diagram for describing the method of recognizing a ship for maritime perimeter monitoring in accordance with an embodiment of the present disclosure of FIG. 3. In the following, a method of recognizing a ship for maritime perimeter monitoring in accordance with an embodiment of the present disclosure will be described focusing on FIG. 3, but FIG. 4 will be referred to as well.

In step S310, a mobile terminal 100 outputs a real-time camera image obtained by capturing the sea with a camera provided in the mobile terminal 100.

In other words, the mobile terminal 100 may be equipped with a ship recognition application that recognizes ships in the camera image obtained by capturing the sea. Thus, the mobile terminal 100 may run the ship recognition application according to a run command of a user, activate the camera of the mobile terminal 100, and output a camera image via the ship recognition application. At this time, the mobile terminal 100 may output a guidance message to capture the sea where perimeter monitoring is desired according to the running of the ship recognition application. Accordingly, the user may check the guidance message and cause the camera of the mobile terminal 100 to point toward the sea where the user wants to conduct perimeter monitoring.

In step S320, the mobile terminal 100 transmits an information request including location information of the mobile terminal 100 to a collection server 200, which collects ship information in real-time, according to the output of the real-time camera image.

Here, the collection server 200 may receive and store ship information of all ships sailing in a preset control area in real-time from the automatic identification system (AIS), V-PASS, ultra-high-speed maritime wireless communication network (LTE-M), or the like. Here, the ship information may include a ship name, ship specifications, current date and time, a call sign (CallSign), an identification number (MMSI), a location (latitude and longitude), a speed (SoG), a course (CoG), a rate of turn, etc.

In step S330, the mobile terminal 100 receives ship information of ships within a preset distance from the location of the mobile terminal 100 from the collection server 200, following the transmission of the information request to the collection server 200.

In other words, the collection server 200 may check the ships within the preset distance from the location of the mobile terminal 100 upon receiving the information request including the location information of the mobile terminal 100, and extract and transmit ship information of the checked ships to the mobile terminal 100 that requested the information.

In step S340, the mobile terminal 100 fuses the ship information into each ship image in the output real-time camera image by using the received ship information, and outputs it.

In other words, the mobile terminal 100 may display the ship information of the corresponding ship around each ship image shown in the real-time camera image by using the location, altitude, and pan-tilt-zoom (PTZ) information of the camera of the mobile terminal 100 and the ship information collected for the ships within the preset distance from the location of the mobile terminal 100.

Here, the displayed ship information may be a ship name, as shown in FIG. 4. And, the mobile terminal 100 may output the entire ship information of the corresponding ship, e.g., the ship name, ship specifications, current date and time, call sign (CallSign), identification number (MMSI), location (latitude and longitude), speed (SoG), course (CoG), rate of turn, etc., via a separate pop-up window, when receiving a touch input to the ship image from the user to view detailed information.

FIG. 5 is a diagram schematically illustrating the configuration of a mobile terminal configured to perform a method of recognizing a ship for maritime perimeter monitoring in accordance with an embodiment of the present disclosure.

Referring to FIG. 5, a mobile terminal in accordance with an embodiment of the present disclosure includes a processor 10, a memory 20, a communication part 30, and an interface part 40.

The processor 10 may be a CPU or a semiconductor device that executes processing instructions stored in the memory 20.

The memory 20 may include various types of volatile or non-volatile storage media. For example, the memory 20 may include ROM, RAM, or the like.

For example, the memory 20 may store instructions for performing the method of recognizing a ship for maritime perimeter monitoring in accordance with an embodiment of the present disclosure.

The communication part 30 is a means for transmitting and receiving data to and from other devices over a communication network.

The interface part 40 may include a network interface and a user interface for accessing a network.

On the other hand, the components of the embodiments described above can be readily understood from a process-wise perspective. In other words, each component can be understood as each process. Further, the processes of the embodiments described above can be readily understood from the perspective of the components of the device.

Moreover, the technical content described above may be implemented in the form of program instructions that can be executed via various computer means and recorded on a computer-readable medium. The computer-readable medium may include program instructions, data files, data structures, and the like, alone or in combination. The program instructions recorded on the medium may be those specially designed and configured for the embodiments or may be those known and available to persons skilled in the art of computer software. Examples of the computer-readable recording media include magnetic media such as hard disks, floppy disks, and magnetic tapes, optical media such as CD-ROMs and DVDs, magneto-optical media such as floptical disks, and hardware devices specially configured to store and execute program instructions, such as ROM, RAM, flash memory, etc. Examples of the program instructions include not only machine language code, such as that created by a compiler, but also high-level language code that can be executed by a computer using an interpreter or the like. The hardware devices may be configured to operate as one or more software modules, and vice versa, to perform the operations of the embodiments.

The embodiments of the present disclosure described above have been disclosed for purposes of illustration, those skilled in the art who have common knowledge of the present disclosure will be able to make various modifications, changes, and additions within the spirit and scope of the present disclosure, and such modifications, changes, and additions should be considered as falling within the scope of the patent claims below.

What is claimed is:

1. A method of recognizing a ship for maritime perimeter monitoring performed by a mobile terminal, comprising:
outputting a real-time camera image obtained by capturing a sea with a camera provided in the mobile terminal;
transmitting an information request including location information of the mobile terminal to a collection server that collects ship information in real-time according to the output of the real-time camera image;
receiving ship information of ships within a preset distance from a location of the mobile terminal from the collection server according to the information request; and
fusing and outputting the ship information into each ship image in the output real-time camera image by using the received ship information.

2. The method of claim 1, wherein the collection server receives and stores ship information of all ships sailing in a preset control area in real-time from an automatic identification system (AIS), a vessel prioritization, allocation, and scheduling system (V-PASS), and an ultra-high-speed maritime wireless communication network (LTE-M).

3. The method of claim 1, wherein the ship information comprises a ship name, ship specifications, current date and time, a call sign, an identification number, a location, a speed, a course, and a rate of turn.

4. The method of claim 1, wherein the fusing and outputting comprises: displaying the ship information around each ship image shown in the real-time camera image by using location, altitude, and PTZ (pan-tilt-zoom) information of the camera of the mobile terminal and the ship information collected for the ships within the preset distance from the location of the mobile terminal.

5. The method of claim 4, wherein the fusing and outputting comprises:
displaying a ship name around each ship image shown in the real-time camera image, and
outputting entire ship information of a touch-inputted ship image via a pop-up window when a touch input to a ship image is received.

6. A mobile terminal configured to perform a method of recognizing a ship for maritime perimeter monitoring, comprising:
a memory configured to store instructions; and
a processor configured to execute the instructions to:
output a real-time camera image obtained by capturing a sea with a camera provided in the mobile terminal;
transmit an information request including location information of the mobile terminal to a collection server that collects ship information in real-time according to the output of the real-time camera image;
receive ship information of ships within a preset distance from a location of the mobile terminal from the collection server according to the information request; and
fuse and output the ship information into each ship image in the output real-time camera image by using the received ship information.
